(19) United States
(12) Patent Application Publication
(10) Pub. No.: US 2007/0073829 A1
(43) Pub. Date: Mar. 29, 2007

(54) Partitioning data across servers

(75) Inventors: Michael D. Volodarsky, Seattle, WA (US); Patrick Y. Ng, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/225,456

(22) Filed: Sep. 13, 2005

(51) Int. Cl. G06F 15/16

(52) U.S. Cl. 709/217

(57) ABSTRACT

A partitioning mechanism is executed on a server that receives a request to determine the connection information that is then used by the server to connect to a back-end data server from which to access the data relating to the request. The partitioning mechanism is directed to horizontally scaling the back-end data storage for web servers by enabling a deterministic partitioning resolution to take place on each web server rather than using a single server to provide the connection information to each of the web servers. The partitioning policy may also be individually developed for each application.

### BACKGROUND

The HyperText Transport Protocol (HTTP) is a protocol that is used to request and serve web resources, such as web pages, graphics, and the like over the Internet. This protocol is used by clients to request data from a web site. Many web site applications access and store information within a single database to determine where to locate the data to fulfill the request. Maintaining this information, however, may create performance issues. For example, when the single database that is used to store this information is accessed by more than one web server in a web server farm, the performance of the web site may be diminished.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A partitioning mechanism is executed on each server that receives requests. The partitioning mechanism determines the connection information to connect to a back-end data server from which the server may access the data relating to the request. The partitioning mechanism is directed to horizontally scaling the back-end data storage for web servers by enabling a deterministic partitioning resolution to take place on each web server rather than using a single server to provide the connection information to each of the web servers. The ability for each web server to determine the connection information, as well as the ability to partition the storage across multiple back-end data storage servers helps to increase the performance and capacity of the web site served by the web servers.

The partitioning policy may also be individually developed for each application. For example, a partitioning policy may be used to determine what data is stored on what servers, and the partitioning policy may also be created to implement such semantics as load balancing, affinity, failover, and the like.

### BRIEF DESCRIPTION OF THE DRAWINGS

FIG. 1 illustrates an exemplary computing architecture for a computer;

FIG. 2 shows a partition resolving system; and

FIG. 3 illustrates a process for partitioning data across servers, in accordance with aspects of the present invention.

### DETAILED DESCRIPTION

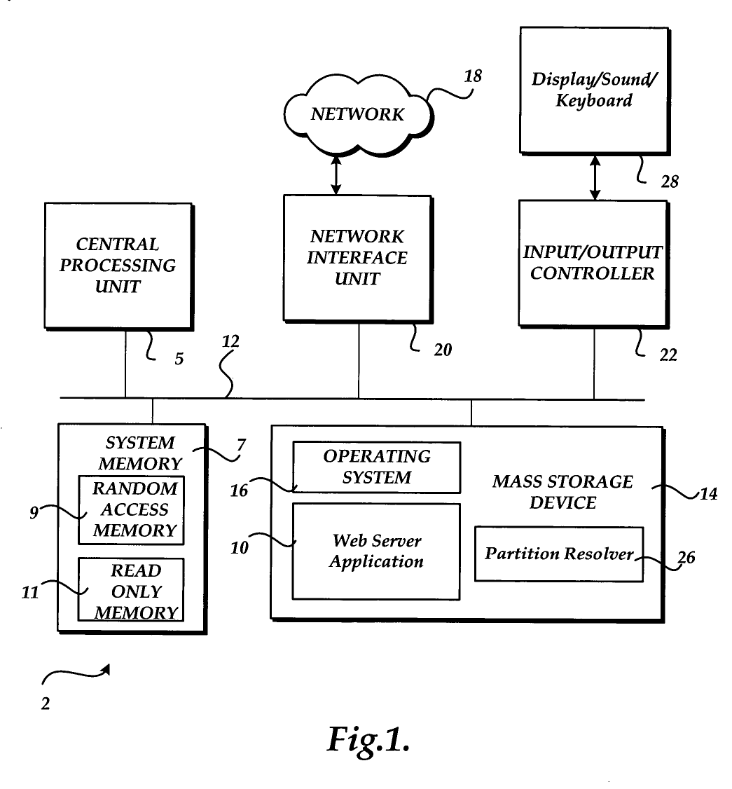

Referring now to the drawings, in which like numerals represent like elements, various aspects of the present invention will be described. In particllar, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an exemplary computer architecture for a computer 2 utilized in various embodiments will be described. The computer architecture shown in FIG. 1 may be configured in many different ways. For example, the computer may be configured as a web server, a personal computer, a mobile computer and the like. As shown, computer 2 includes a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments, the computer 2 operates in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems.

The computer 2 may also include an input/output controller 22 for receiving and processing input from a number of devices, such as: a keyboard, mouse, electronic stylus and the like (28). Similarly, the input/output controller 22 may provide output to a display screen, a printer, or some other type of device (28).

As mentioned briefly above, a number of program modules and data files may be stored in the mass storage device 14 and RAM 9 of the computer 2, including an operating system 16 suitable for controlling the operation of a networked computer, such as: the WINDOWS XP operating system from MICROSOFT CORPORATION; UNIX; LINUX and the like. The mass storage device 14 and RAM 9 may also store one or more program modules. In particular, the mass storage device 14 and the RAM 9 may store a web server application program 10. According to one embodiment, the web server application 10 is used to provide support for an e-commerce site. The web server application program 10 is operative to provide functionality for receiving a request from a client and then utilizing partition resolver 26 to determine the connection information that is used to connect to a back-end data server.

Typically, web server application 10 receives a request from a client's browser application on a client computing device to retrieve hypertext documents from the Internet. A WWW browser, such as Microsoft's INTERNET EXPLORER®, is a software browser application program that may be used in requesting the data.

Upon receiving the request from the user via the browser, the web server application 10 retrieves the desired data from the appropriate data server utilizing: the partition resolver 26, the request that includes an associated identifier (ID) and HTTP. HTTP is a higher-level protocol than TCP/IP and is designed for the requirements of the Web and is used to carry requests from a browser to a Web server and to transport pages from Web servers back to the requesting browser or client.

Generally, partition resolver 26 maps the ID that is associated with the request and creates a connection string that identifies the data server to access such that the requested data may be obtained. Additional details regarding the operation of the partition resolver 26 will be provided below.

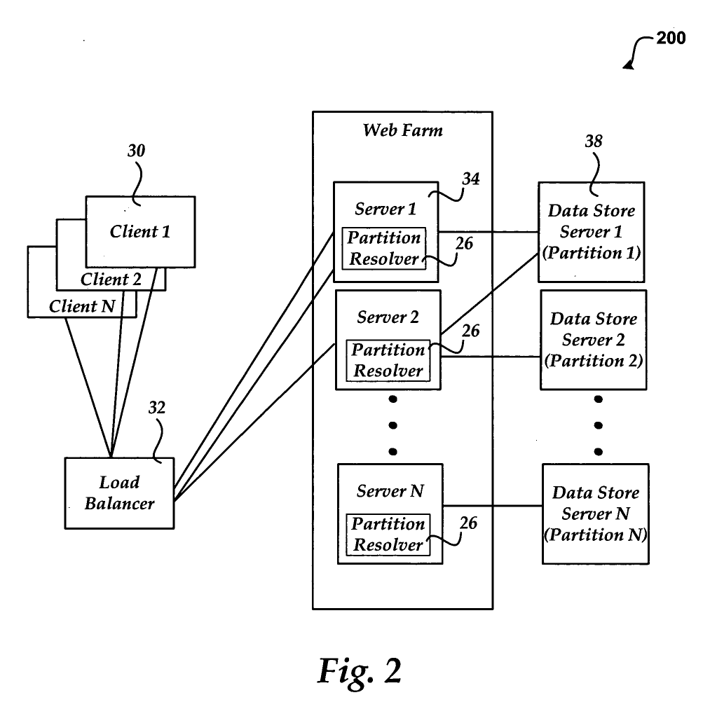

FIG. 2 illustrates a partition resolving system 200, in accordance with aspects of the invention. As described briefly above, the partition resolver 26 directs the web server that receives the request from the client to the appropriate back-end data store server. Any time a request is received by a server in the web farm, the partition resolver 26 applies a deterministic algorithm to determine the data store server to access. According to one embodiment, each partition resolver 26 provides connection information to the appropriate data store server in response to requests that are associated with e-commerce applications such that the associated session state information may be spread across the data store servers 38. The partition resolver 26 allows data to be partitioned across any existing data service without caring about its implementation or requiring that data service itself support partitioning. As such, this makes the partition resolver an effective and simple way to enable partitioning in existing systems without the need to reimplement the systems themselves. Instead, a modification to the application layer may be made to enable the partitioning of an existing system.

Although some database programs may include functionality to spread data across multiple servers, this sharing is accomplished through expensive software at the data store server end and can be prohibitively expensive to implement. For example, some SQL servers may implement clustering which may appear to the user as a single SQL server rather than two or more SQL servers.

As illustrated, clients 1-N (30) are configured to generate requests to a web site utilizing the servers (1-N) in the web farm. In response to the request, the server retrieves data from one of the back-end data store servers (38). For example, the client could include a browser application that is requesting a page update for an e-commerce website the user is shopping on. When the request is received, the partition resolver 26 residing on the web server that receives the request determines the data store server to access. Instead of the connection information being hard-coded and retrieved from only one server, the partition resolution occurs on a per request basis, enabling each client request to the web server to use the appropriate data store server to obtain the data.

As illustrated, servers 1-N are part of a web farm. A web farm is a group of networked servers that are used to distribute the workload between the individual servers of the farm. The web farm is used to run a web site, such as an e-commerce site. Typically, the web farms utilize a load balancer 32 to balance the load across the servers in the web farm.

Partition resolver 26 accesses the identifier associated with the request and maps the request to the corresponding data server. Each web server in the web farm maintains a partition resolver to determine which data store server should be used. The mechanism is not dependent upon the database utilized by the data store server. Once the partition resolver creates the connection string, the processing occurs as it normally would have without the use of the partition resolver. According to one embodiment, the partition resolver 26 is used to maintain session state for a client, such as client 30. Generally, session state is a mechanism that is used to maintain the state associated with each web browser client, allowing the server in the web farm that is handling the request to remain aware of the client across all of the client's requests within a predefined time period. According to one embodiment, in Microsoft's ASP.NET 2.0, the partition resolver 26 integrates with the existing implementation of SQL Server and State Server session state storage mechanisms, allowing each application to easily configure partitioning with one or more state storage servers.

Typically, session state implementations associate an identifier (ID) with the client in such a way that the client remembers the ID, and always provides the server with it when a request is made. For example, the client may receive a cookie in response from the first server to which it makes a request. According to one embodiment, MICROSOFT's ASP.NET session state implementation supports both Uniform Resource Location (URL)-based and HTTP cookie-based IDs. Any server that receives a request from the client after the client has received the cookie uses the ID to determine the connection information to locate a server-side store of session state, thereby associating the state for that client with the web browser across multiple requests.

Without utilizing the partition resolver 26, session state systems suffer from the capacity and performance bottleneck that occurs when utilizing a single state storage server. For example, when only a single store server is utilized and multiple clients make requests to the application's web farm the request to the single session state server becomes a bottleneck for the application. To provide stateful execution, each server must contact the session state store server to obtain the state for the request its processing. The session state store server, therefore, may become a bottleneck.

According to one embodiment, the partition resolver 26 includes an API that allows a user to plug in and create partitioning policies. In other systems, the connection information is hard coded by the system administrator and points at the single session state store server.

The policies may be as simple or complex as the user desires. According to another embodiment, the partition resolver 26 could be configured to implement a predefined partitioning policy.

The following object illustrates an exemplary partition resolving object. The partition resolving object implements the partition interface that defines the following contact:

```
public interface IPartitionResolver
{
    void Initialize( );
    string ResolvePartition(Object key);
}
```

The web server application can implement the partition interface to provide partition resolution for the state mechanism and enable it to connect to the appropriate server on each request. According to one embodiment, in MICROSOFT'S ASP.NET, the type of the provider object is specified in the session state configuration for the application, and can then be used with one of the existing session state store implementations such as SQL Server or State Server.

Utilizing the partitioning mechanism, the application may implement any deterministic partitioning algorithm and may provide features such as load balancing, affinity, and failover. For example, one simple implementation of the partition resolving object can: maintain a configured list of available data store servers; on each request, resolve the ID to one of the available data store servers by hashing it into a partition table; and return the connection information for the selected data store server.

More complex implementations can take advantage of the session ID generation control feature in the session state to generate SIDs for new sessions based on a load balancing algorithm. Any load balancing algorithm may be implemented, such as round robin or a more complex load balancing algorithm. The partition resolving object selects the partition based on such an algorithm, and encodes it into the SID that is given to the client. Subsequently the partition resolving object selects the state server based on the information in the SID provided by the client, thereby enabling data partitioning with load balancing for state servers.

Data may be transmitted between the clients and the servers illustrated in FIG. 2 over many types of networks, including but not limited to a wide area network (WAN)/local area network (LAN) and/or a cellular/pager network. The cellular/pager network is utilized to deliver and receive messages from wireless devices. The cellular/pager network may include both wireless and wired components. For example, cellular/pager network may include a cellular tower that is linked to a wired telephone network. Typically, the cellular tower carries communication to and from cell phones, long-distance communication links, and the like. A gateway may also be used to route messages between the cellular/pager network and a WAN/LAN. For example, a cellular phone may send a request to a server in which the gateway provides a means for transporting the message from the cellular/pager network to the WAN/LAN. The gateway also allows HTTP messages to be transferred between the WAN/LAN and the cellular/pager network.

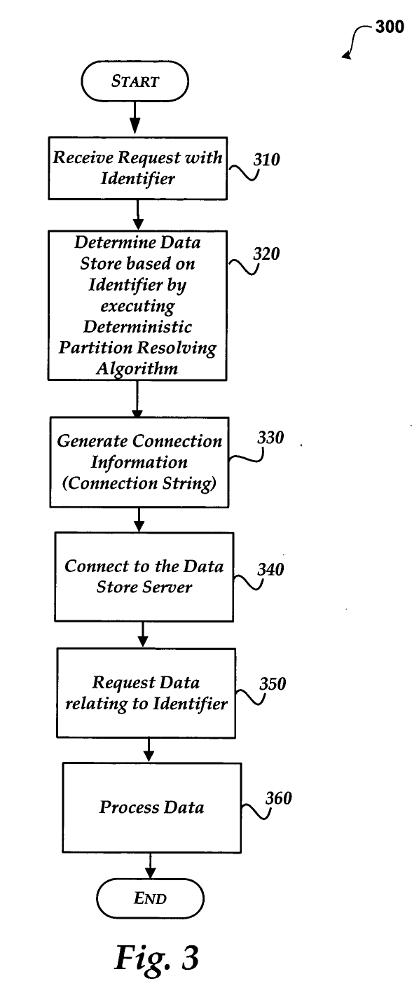

Referring now to FIG. 3, an illustrative process for partitioning data across servers will be described. Although the embodiments described herein are presented in the context of a partition resolver 26 and a web server application program 10, other types of application programs may be utilized. For instance, the embodiments described herein may be utilized by any web application that responds to requests from clients in which a state of the session needs to be maintained.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

After a start operation, the process flows to operation 310 where the request that includes an identifier is received. According to one embodiment, the ID is a session identifier (SID). The ID, such as an SID, is used to represent the client's session.

Moving to operation 320, a deterministic partition resolving algorithm is executed to determine the data store to access. Instead of using statically configured connection information, a partition resolving object with the ID is instantiated. According to one embodiment, the partition resolving object is provided by a user, such as a system administrator.

Flowing to operation 330, the resolving object uses the SID and any other applicable information available to it that is associated with the application to generate the connection information for the server on which the data (session) should reside.

Moving to operation 340, the process connects to the data store server using the appropriate mechanism. For example, the appropriate mechanism may be a database driver, a direct network connection, and the like.

Transitioning to operation 350, the data relating to the ID is requested. According to one embodiment, the data relates to a state for the specified SID.

The process then flows to operation 360, where the data is obtained and processed.

The process then moves to an end block where it returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for determining a data store server, comprising:
receiving a request for data that includes an identifier; wherein the request is received at a server;
dynamically determining a data store server from which to retrieve the data; wherein the determination occurs on the server and wherein the identifier is used in the determination; and
connecting the server to the data store server based on the determination.

2. The method of claim 1, further comprising generating a connection string that identifies a location of the data store server that is used by the server to connect to the data store server.

3. The method of claim 2, wherein generating the connection string comprises generating the connection string on the server for each received request.

4. The method of claim 1, wherein determining the data store server comprises determining the data store server from one of many data store servers.

5. The method of claim 1, wherein determining the data store server comprises mapping the identifier to the data store server using a deterministic partition resolving algorithm.

6. The method of claim 5, wherein the deterministic partition resolving algorithm may be created by a user.

7. The method of claim 5, further comprising using the partition resolving algorithm to implement at least one of: load balancing, affinity, and failover.

8. The method of claim 5, further comprising utilizing a partition resolving object to access the partition resolving algorithm.

9. The method of claim 8, wherein the partition resolving object is configured to maintain a configured list of available data storage servers; and upon on each request that is obtained, resolve the identifier to one of the available data storage servers by hashing it into a partition table; and returning the connection information for the selected data storage server.

10. A computer-readable medium having computer-executable instructions for session state partitioning, comprising:
receiving a request for data; wherein the request includes a session identifier and wherein the request is received by a first computing device;
applying a deterministic partition resolving algorithm at the first computing device; wherein applying the algorithm generates a connection string that provides a location of a second computing device from which to retrieve the data; and
connecting the first computing device to the second computing device using the connection string.

11. The computer-readable medium of claim 10, wherein generating the connection string comprises generating the connection string on the first computing device each time a request is received and wherein the connection string is dynamically generated.

12. The computer-readable medium of claim 11, wherein the first computing device is a web server that is part of a web farm and wherein the second computing device is a back-end data store that is one of many back-end data stores.

13. The computer-readable medium of claim 11, wherein the deterministic partition resolving algorithm comprises hashing the session identifier to determine the location of the second computing device.

14. The computer-readable medium of claim 11, wherein the session identifier identifies a session that relates to a user's interaction with an e-commerce web site.

15. The computer-readable medium of claim 10, wherein the partition resolving algorithm is configured to maintain a configured list of available second computing devices; resolve the session identifier to one of the available second computing devices; and return the connection information for the selected second computing device.

16. A system for determining a connection string to access a back-end data storage server, comprising:
web servers that are coupled to a network and comprise:
an application that is configured to receive a request from a client computing device that includes an identifier that identifies a client session; and a
a partition resolver that is configured to create the connection string that is used to access the back-end data storage server by using a deterministic partition resolving algorithm to the identifier; wherein the partition resolver may be included on web servers that do not initially provide data partitioning services; and
back-end data storage servers that are coupled to the web servers that are configured to provide data in response to receiving a request from one of the web servers.

17. The system of claim 16, wherein the partition resolver may implement any deterministic partition resolving algorithm to provide at least one of: load balancing, affinity, and failover.

18. The system of claim 16, wherein the deterministic partition resolving algorithm comprises hashing the identifier to determine the location of the second computing device.

19. The system of claim 16, wherein the web servers are configured to support an e-commerce web site.

20. The system of claim 16, wherein the partition resolving algorithm is configured to maintain a configured list of available back-end data storage servers and resolve the identifier to one of the available back-end data storage servers.
